(19) United States
(12) Patent Application Publication
(10) Pub. No.: US 2003/0140058 A1
(43) Pub. Date: Jul. 24, 2003

(54) Method and apparatus for sharing information between applications using common objects

(75) Inventors: Thomas J. Martin, Fremont, CA (US); Marion Dale Skeen, Menlo Park, CA (US)

Correspondence Address: NIXON PEABODY, LLP, 8180 GREENSBORO DRIVE, SUITE 800, MCLEAN, VA, 22102, US

(73) Assignee: VITRIA TECHNOLOGY, INC.

(21) Appl. No.: 10/080,928

(22) Filed: Feb. 25, 2002

Related U.S. Application Data
(60) Provisional application No. 60/350,351, filed on Jan. 24, 2002.
(60) Provisional application No. 60/354,235, filed on Feb. 6, 2002.

(51) Int. Cl. G06F 7/00

(52) U.S. Cl. 707/103 R

(57) ABSTRACT

A computer architecture for sharing information between plural applications having disparate data structures. An application integration platform includes logic for exchanging information between the plural applications. At least one common object definition specifies common objects to be used for exchanging data between the applications. The common object definition includes a canonical object defining elements of a standard object that are common between data structures of the applications. The comon object also includes at least one extension defining application specific or user specific elements. The canonical object is exposed to all of the applications through the application integration platform and the extensions are being exposed only to selected applications.

### RELATED APPLICATION DATA

This application is related to copending application Ser. No. 09/984,977 filed on Oct. 31, 2001, the disclosure of which is hereby incorporated herein by reference. This application claims benefit from provisional application Ser. Nos. 60/350,351 filed on Jan. 24, 2002 and 60/354,235 filed on Feb. 6, 2002 the disclosures of which are also incorporated herein by reference.

### BACKGROUND

It is well known to automate various business systems, such as Customer Relations Management (CRM), Enterprise Resource Planning (ERP), accounting, inventory control, order processing and the like. Historically, such systems were each handled by dedicated software applications that did not integrate well with each other. Such applications were custom built for a specific need being addressed and often utilized proprietary protocols. Dedicated “point to point” connections were developed to permit each such system to communicate with another such system. For example, an inventory control system may exchange data with an accounting system through a customized software interface. However, as the number of systems increases, the quantity and complexity of point to point connections also increase. Further, point to point connections are rather inflexible and do not facilitate reconfigurations of systems to accommodate changing business models.

The concept of “Enterprise Application Integration” (EAI) refers to the sharing of data throughout applications and data sources in an organization. As enterprises grow and require increased flexibility of data sharing throughout various systems, EAI is used to streamline processes and keep all the elements of the enterprise interconnected. EAI can include database linking, application linking, and data warehousing.

Various systems for accomplishing EAI are well known. For example, Service Oriented Architectures (SOA), in which a common set of services are exposed by different layers, are known. Also, Event Oriented Architectures (EOA) in which a publish/subscribe messaging system is used to change the states of activities based on events, is known. Further, standard connectivity protocols and message formats such as Remote Method Invocation (RMI) and eXtensible Markup Language (XML) have been established to facilitate EAI.

More recently, the concept of a Common Information Model (CIM) has been investigated for providing inter-operability between disparate applications and data sources. The CIM paradigm uses “common objects” for sharing information between applications. The common objects are specified to include data elements that are common between the various data structures of the applications. Data, such as events, from each application are transformed into the appropriate common object, published or otherwise communicated to a synchronization system, and then transformed to the data structure of the application to which the data is to be communicated to update records in the application. In this manner, transformations need only be accomplished between each application and the common object. It is not necessary to accomplish a transformation between each individual application and every other application.

As an example, Distributed Management Task Force, Inc. (DMTF) promulgates an object oriented information model used to communicate occurrences of events. Also, Open Applications Group (OAG) has published a set of XML-based standards that define business object inter-operability between enterprise business applications. The OAG standard is called the “Open Applications Group Integration Specification (OAGIS)” and includes 182 common business object documents specifying 182 transactions potentially used to complete business transactions such as order taking, shipping, and the like.

Known common objects take one of two approaches. The first approach is to include, as elements in the common object the universe of data elements in the data structures of the various applications that potentially may be part of the CIM system. The second approach is to include, as elements in the common object, only the essential data elements of data structures of the various applications that potentially may be part of the CIM system.

The first approach permits much of the functionality of the individual systems to be retained for use in the CIM system. For example, a customer relationship management application may have a data structure that includes a data element indicating the time and date of the last phone conversation with the customer contact. Such a data element is not likely to be of any significance to an accounting application or other system. However, if the common object is the universe of all data elements, the data element indicating the time and date of the last phone conversation will be retained to be used by the CRM system. However, common objects that include the universe of all data elements for plural potential applications become quite large and cumbersome and thus consume a great deal of resources and slow down the overall system.

On the other hand, common objects taking the second approach noted above, are generally smaller and less cumbersome to manipulate and maintain. However, since only the subset of essential data elements are used, much of the functionality of individual applications can be lost. Returning to the example noted above, the data element indicating the time and date of the last phone conversation would not be retained in a comon object if only the CRM system used the data element. Therefore, the CRM system would not know the date and time of the last phone conversation with the customer for events promulgated through the CIM system.

Known CIMs provide for custom extensions, i.e. the addition of custom data elements, to the common objects. However, such extensions become part of the common object for use by each application and are thus, at best, a compromise between the limitations of the two approaches noted above. Also, known CIM specifications do not provide a repeatable methodology for creating common objects and extensions thereto. Accordingly, the use of extensions can result in inconstancies and incompatibilities, thus frustrating the original purpose of the CIM.

Further, known CIMs have limitations with respect to data synchronization and error handling. In particular, records created/updated/deleted in one application have to be created/updated/deleted in other applications. If one or more systems are down during manipulation of a record, incomplete synchronization can result in conflicts between corresponding records in different applications. To minimize the potential for incomplete synchronization, known CIM systems ordinarily have a single system of record, i.e. a master system. All records must be created, deleted, and updated in the master system and changes are propagated as events through the appropriate common object. Of course, the use of a single master reduces the complexity of the synchronization system but also reduces the flexibility thereof. It is known to permit multiple systems of record. However, such systems are complex and often have event “collisions” in which a record is changed on two systems simultaneously and records are not properly synchronized between systems.

### SUMMARY OF THE INVENTION

An aspect of the invention is a computer architecture for sharing information between plural applications having disparate data structures, an architecture comprising, plural applications, at least one of the applications having a data structure that is different from another of the applications, an application integration platform including logic for exchanging information between the plural applications, at least one common object definition specifying common objects to be used for exchanging data between the applications and including a canonical object defining elements of a standard object that are common between data structures of the plural applications, a comon object further including at least one extension defining application specific or user specific elements, a canonical object being exposed to all of the applications through the application integration platform, and an extension being exposed only to selected ones of the plural applications.

### BRIEF DESCRIPTION OF THE DRAWING

The invention is described through a preferred embodiment and the attached drawings in which:

FIG. 1 is a block diagram of a computer architecture of the preferred embodiment;

FIG. 2 is a block diagram illustrating the record update procedure of the preferred embodiment;

FIG. 3 is a schematic illustration of a common business object of the preferred embodiment;

FIG. 4 is an example of a common object definition of the preferred embodiment;

FIG. 5 is a flow chart of a method for creating a common object definition in accordance with the preferred embodiment; and

FIG. 6 is a block diagram of an example of a transformation map of the preferred embodiment.

### GLOSSARY

The description herein uses terms of art as defined below.

Document Type Definition (DTD)—a type of file associated with documents, such as XML and SGML documents, that defines how the data elements of the document should be interpreted by the application presenting the document.

Common Business Object (CBO)—an instance of a common object definition.

Common Object Definition—a specification of a standard business object to be used to share information between applications having disparate data structures.

Record—an application specific business object.

### DETAILED DESCRIPTION

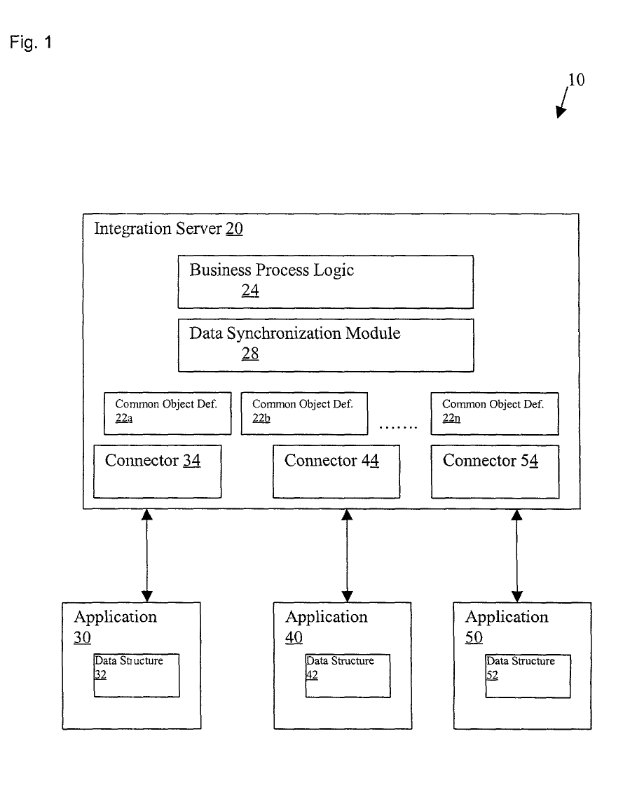

FIG. 1 illustrates computer architecture 10 in accordance with a preferred embodiment of the invention. Integration server 20 serves as an integration platform and includes business process logic 24 for controlling business processes, data synchronization module 28, plural common object definitions 22a, 22b, . . . 22n, and connectors 34, 44, and 54. For example, integration server 20 can be a computer server running the Vitria BusinessWare Automator™ and can include the modeling environment disclosed in the parent application Ser. No. 09/984,977 incorporated herein by reference. Data synchronization module 28 can be in the form of a process model configured to implement the synchronization routines described in detail below. Connectors 34, 44, and 54 can each include process logic (in the form of process models or the like) and transformation maps to convert application specific events and payload of applications 30, 40, and 50 respectively to the format of the appropriate common business objects.

Common object definitions 22a, 22b, . . . 22n are each a specification of data elements of a common business object selected in accordance with the methodology described below, for example. By using one common definition for corresponding business objects, plural applications 30, 40, and 50, having unique data structures 32, 42, and 52, can communicate through the CBOs. Various applications often refer to the data in the CBOs differently. A CRM system, for example, might refer to a customer as an “Account” while an ERP system might refer to a customer as a “Customer”. Every system assigns a unique identifier for each relevant CBO to refer to the object. In the preferred embodiment, a cross-reference system is used to develop a common key to translate one application's identifier within a common object to the other systems identifier as described below.

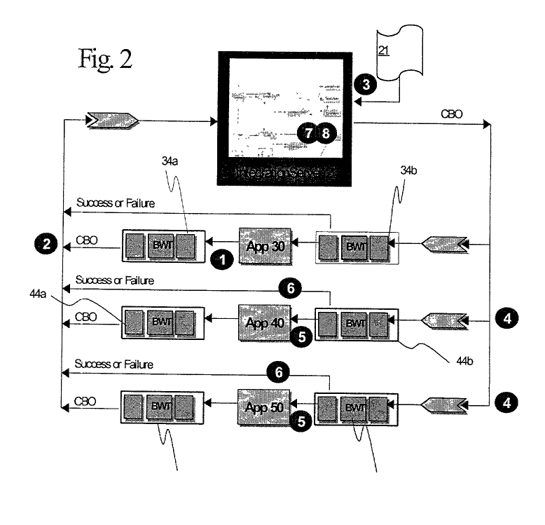

FIG. 2 illustrates an example of the operation of the preferred embodiment wherein a master application, application 30 in the preferred embodiment, manages a business object, e.g., “Account”, and a set of slave applications, applications 40 and 50, also maintain images of this same business object as records. The preferred embodiment provides the services for managing the entire life cycle of the objects, including Create and Update transactions. The following steps describe the synchronization process of the preferred embodiment with Reference to FIG. 2.

Application 30, the master application in this example, creates or updates a record and a source portion 34a of connector 34 captures the application record creation in step 1. In step 2, the application specific record is transformed into the corresponding CBO by source portion 34a and published to a channel or other device which makes the CBO available to business process logic 24. The corresponding CBO has been designated in advance based on the type of records created. For example, the CBO can be an inventory CBO which is defined by common object definition 22a. In step 3, business process logic 24 reads configuration file 21 to determine which applications should be updated by the type of CBO output by source portion 34a in step 2. Configuration file 21 can be a database, a lookup table, a list, or any type of indication of which applications need to be updated by each CBO.

In step 4, business process logic 24 of integration server 20 publishes the CBO to one or more channels corresponding to the applications specified in configuration file 21 to thereby make the CBO available to the relevant applications, applications 40 and 50 in this example. Target portions 44b and 54b of connectors 44 an 54 respectively receive the CBO instance and transform the CBO into application-specific data structures 42 and 52 corresponding to applications 40 and 50 respectively. The corresponding records are then created or updated in each application of interest, applications 40 and 50 in this example, by invoking the Application Programming Interfaces (APIs) via target portions 44b and 54b in step 5.

In step 6, success or failures of create and update events are communicated back to business process logic 24 through a channel in the form of response events. After successful manipulation of the corresponding records in all systems of interest, business logic 24 waits for updates to that object. In the case where step 6 results in a failure, the record is moved to an exception state and the error handling described below can be used.

The preferred embodiment allows a user to define, in a graphical manner, how errors should be handled within the context of system 10. Based on the type of error, operation being executed, and data in the common business object, a user may choose to handle the error differently. For example if the CRM/ERP system is off line or unavailable the user may choose to have the operation re-tried. But if the error was that the corresponding record could not be created in the other system the user may wish to delete/inactivate the record in the original system. By allowing the user to handle different types of errors in the context of what failed and why error resolution can be automated based on preset rules. The rules can be created to require human intervention at which time a user will have complete flexibility to decide weather to re-try the operation, fix some data or issue a different command to the various systems.

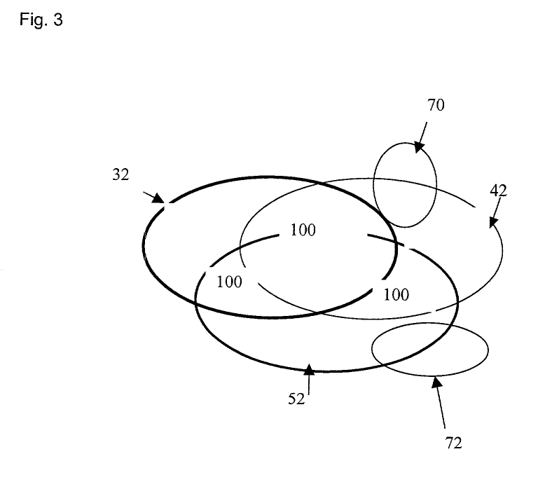

The CBOs of the preferred embodiment are multifaceted and are comprised of at least three distinct components. FIG. 3 schematically illustrates an exemplary CBO in accordance with the preferred embodiment. Data structures 32, 42, and 52 correspond to applications 30, 40, and 50 respectively. The data structures can be of any form and are merely represented in FIG. 3 as ellipses for illustration. Assuming that applications 30, 40, and 50 are the key applications for system 10, the data elements that are common to at least two of the applications are included in canonical object 100. Canonical object 100 can be adjusted to be skewed, i.e. more closely comply, with any relevant standard object, such as an OAG common object. Next, user specific data 70, such as data from a user's primary application 40 and other data relevant to the user, can be added to the object as an extension to the canonical object 100. Further, vertical data elements 72, such as data elements from an application common to a specific industry, can be added as an extension to canonical object 100.

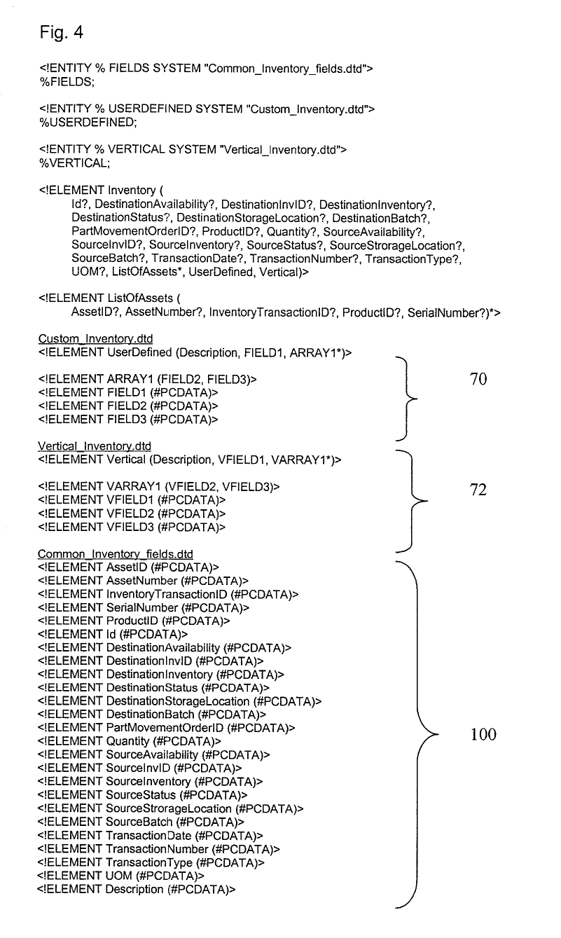

Each section of a common object definition is constituted of a distinct DTD. FIG. 4 is an example of common object definition 22a which corresponds to an inventory object in the preferred embodiment. As illustrated in FIG. 4, common object definition 22a includes a header defining the structure of the CBO and placeholders for user data extension 70 and vertical data extension 72, and Common_inventory_fields.dtd which is a set of the elements in canonical object 100. Further, Vertical_inventory_fields.dtd defines the set of data elements in vertical data extension 72 and custom_inventory_fields.dtd defines the data elements in user data extension 70. In the preferred embodiment, the common object definitions are expressed as XML DTDs. However, the common object definitions can be expresses as XML schema, or any other type of data dictionary, schema, or other format to define the elements of the appropriate CBO.

Since, much of the information is common among the various CBOs, a common object definition typically aggregates other common object definitions. Therefore, a CBO can merely reference a unique ID of the aggregated CBOs. Connectors 34, 44, and 54 can derive any additional attributes of a CBO if the unique ID is provided. As such, the canonical object can contain IDs of the aggregated CBOs. The cross-reference model described below substitutes the originating application specific IDs into the destination specific IDs. Hence, when the framework is deployed, every application is guaranteed to receive its own objects IDs in the CBO.

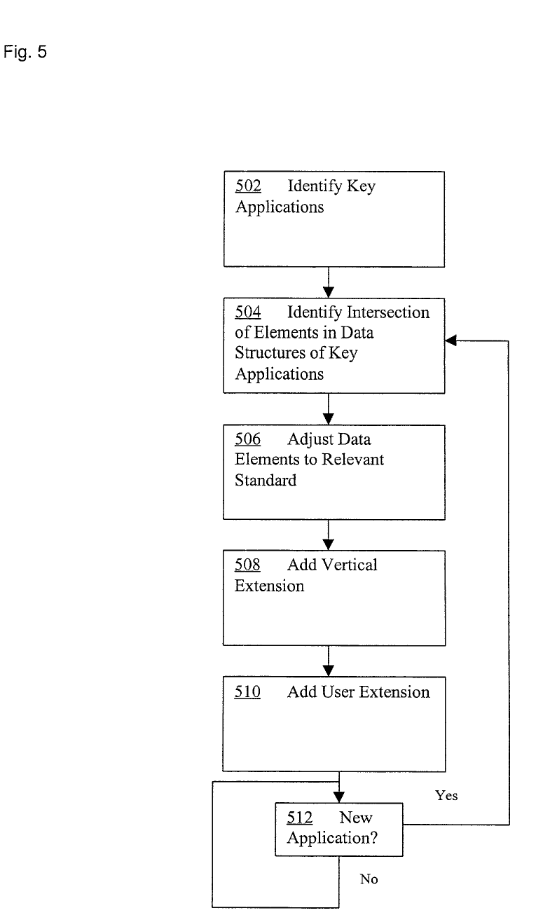

FIG. 5 illustrates a methodology for creating common object definitions of the preferred embodiment. In step 502, key applications to be used in system 10 are identified. The key applications can be applications currently being integrated by system 10 and/or applications that may be integrated by system 10 in the future. However, as will be seen below. Subsequent additions of applications can be accounted for later due to the extensibility of the common object definitions and thus it may be desirable to exclude potential applications to reduce overhead. In step 504, the intersection, i.e. the overlap, of data elements of the data structures of the key applications is identified. In step 506, the intersection is adjusted to any relevant standard. For example, if the common object definition has a corresponding common object in a standard, such as the standard OAG common object, selected data elements in the standard common object can be included in the canonical object to increase inter-operability with standards based systems. Steps 502, 504, and 506 yield canonical object 100 described above.

In step 508, a vertical extension can be added to the comon object definition. For example, industry specific data elements can be added as the vertical extension. In step 510 an application specific extension can be added to the comon object definition. For example, application specific data elements can be added as the vertical extension to retain functionality of various applications. In step 512, when a new application is to be added to system 10, the procedure can return to step 504 for consideration of data elements in the data structure of the new application. The use of extensions permits application specific and industry specific data to be included in a common object without requiring all applications to parse all of the data elements. For example application 40 can ignore data elements in an extension that is specific to application 40. This reduces overhead.

A cross reference model is used to correlate elements in various records of various applications. There are two types of cross-referencing that are important when exchanging data between applications. Reference data is that data which are simple values that must be converted from one system's dialect to another for example one system may use the value “Each” while the other system uses “Ea”. Thus when data is received from a system, the value must be normalized to the Global Identifier for that term. Then when data is sent to a system the Global Identifier must be de-normalized to that systems specific value. Transactional data is that data that usually references to complex objects rather then simple values. For example a Sales Order object may reference a Customer object, placing the unique id of the Customer object in Sales Order object accomplishes this. Then the same logic applies, when a Sales Order is received the Customer reference must be normalized to the Global ID for that Customer. And when that Sales Order is sent to a different system that systems specific ID for Customer must be placed in the Sales Order. A simple table in a database with four columns permits any number of cross-reference values can be managed for any object, including reference and transactional data. The table contains columns for: Global Id, System Name, System Type, and System key. However, any number of columns can be used to accommodate the desired cross referencing data. Further, the model can use a table, database, data mapping arrangement, or any other mechanism to achieve the desired cross referencing. Once the data structure of an application is normalized by being transformed to a CBO the cross reference model is used to establish common keys for each CBO instance during an initial load event. During the initial load event, reference data residing in the various applications are matched and moved to the lookup table with the correlated ID of the corresponding CBO.

As illustrated in FIG. 4, each common object definition is expressed as a tree structure of data. This permits segregation of data elements so that different applications can be responsible, i.e. masters of, different groups of data elements. This permits a system of record control scheme to be implemented in accordance with various system of record policies. For example, a conventional single system of record policy can be used in which a designated application, such as master application 30, propagates records in one system, through CBOs, to corresponding records in all other systems. Changes in systems other than the master will not be propagated to other systems and may even be prohibited or overwritten.

However, it can be seen that the single system of record policy has limitations because not all data is ordinarily collected through a single application or system. In fact, as noted above, any given CBO may have elements that are not in the data structure of any given application. Accordingly, the preferred embodiment also provides for a “federated” update policy in which different applications take ownership of different portions of given CBOs. For example, a Customer Relationship Management (CRM) application can control and update all customer related data in a CBO and an accounting system can control and update all of the accounting data in the same CBO. The tree structure of the comon object definitions and the CBOs facilitates this by allowing a given application to merely parse and process specific nodes of a CBO when updating the CBO. Federated control permits the application through which data is likely to be entered to then propagate the data to other systems without the conflicts involved when each system updates objects in their entirety.

Another update policy of the preferred embodiment is a “revolving” update policy in which the system of record can change over the life cycle of the CBO. For example, a CRM application can handle updates of a CBO from the time of opening an account until items have been shipped in correspondence to the CBO at which point an accounting or enterprise resource planning (ERP) system can take over. In this manner, the system most closely related to handling the CBO at a given point in its life cycle controls updates of the CBO. In the revolving update policy, one or more applications can be responsible for updating a CBO at any given time. For example, this policy can be combined with the federated policy described above.

Another policy of the preferred embodiment is a rules based policy in which CBOs are selectively updated based on data in the object or external factors. For example, a CBO may be updated and propagated only when certain elements thereof are affected and only when a previous update has not occurred in the last hour. Any types of rules and logic can be applied to the update policy. Also, the rules based policy can be combined with other policies.

As described above, connectors 34, 44, and 54, each include transformation maps to permit conversion between application data structures and the common objects. In the preferred embodiment, the transformation maps are modular to permit mapping to take place in stages. In particular, when custom extensions are added to CBOs, the corresponding transformation maps must be changed to accommodate the extensions. However, upon a new installation or a reinstallation, the customization in the maps may be lost. Further, various departments in an enterprise may have various customizations requiring management and manipulation of a very complex transformation map for each CBO of each department.

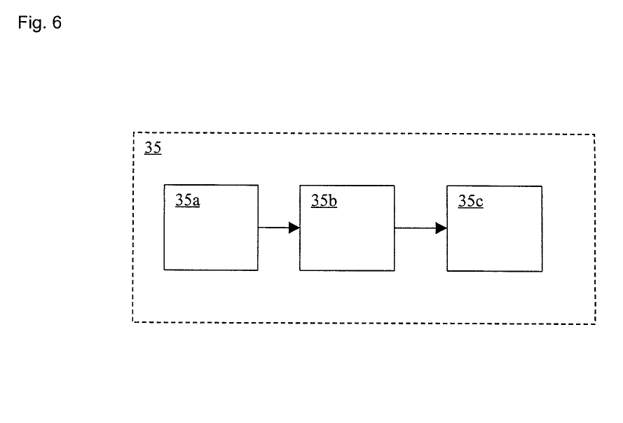

FIG. 6 illustrates an example of a transformation map 35 of the preferred embodiment. Transformation map 35 is comprised of canonical object map 35a, user extension map 35b, and vertical extension map 35c. As an example, a CBO is input into transformation map 35 and canonical object map 35a maps the data elements of canonical object 100 to corresponding data elements of the target application. The output of canonical object map 35a is input into user extension map 35b which maps the data elements of user extension 70. The output of user extension map 35b is then input into vertical extension map 35c which maps the data elements of vertical extension 72. Additional mapping components can be added for various extensions. It can be seen that when the user extensions of a CBO are modified, only user extension transformation 35b need be modified. Further, transformation maps can be built of component transformation maps to provide a great deal of flexibility.

The invention can be implemented on any device, such as a personal computer, server, or any other general purpose programmable computer or combination of such devices, such as a network of computers. Communication can be accomplished through any communications channel, such as a local area network (LAN), the Internet, serial communications ports, and the like. The communications channels can use wireless technology, such as radio frequency or infra-red technology. The various elements of the preferred embodiment are segregated by function for the purpose of clarity. However, the various elements can be combined into one device or segregated in a different manner. For example, software can be a single executable file and data files, or plural files or modules stored on the same device or on different devices. Any protocols, data types, or data structures can be used in accordance with the invention. The invention can be used to design, create, manipulate, test or use any collaborative application can be used in combination with any type of system for affecting business processes or other functions. Any appropriate user interface can be used to design, create, and manipulate models. The underlying code can be written in any language.

The invention has been described through a preferred embodiment. However, various modifications can be made without departing from the scope of the invention as defined by the appended claims and legal equivalents thereof.

What is claimed:

1. A computer architecture for sharing information between plural applications having disparate data structures, said architecture comprising:
plural applications, at least one of said applications having a data structure that is different from another of said applications;
an application integration platform including logic for exchanging information between said plural applications; and
at least one common object definition specifying common objects to be used for exchanging data between said applications and including a canonical object defining elements of a standard object that are common between data structures of said plural applications, said comon object further including at least one extension defining application specific or user specific elements, said canonical object being exposed to all of the applications through said application integration platform, said extension being exposed only to selected ones of the plural applications.

2. A computer architecture as recited in claim 1, wherein said at least one extension comprises an application specific extension having data elements used only by a first of said plural applications and a user specific extension having data elements not in said canonical object but desired by a specific user.

3. A computer architecture as recited in claim 1, wherein said common object definition comprises a tree like structure.

4. A computer architecture as recited in claim 3, wherein each of said canonical object and said extensions are represented by a separate node in said common object definition.

5. A computer architecture as recited in claim 3, wherein each of said canonical object and said extensions are represented by a distinct DTD in said common object definition.

6. A computer architecture as recited in claim 3, wherein said common object definition references another common object definition.

7. A computer architecture as recited in claim 1, further comprising means for cross referencing data elements in said common object definition with corresponding data elements in said applications.

8. A computer architecture as recited in claim 1, wherein said application integration platform is operative to enforce plural system of record policies.

9. A computer architecture as recited in claim 8, wherein said system of record policies include a federated policy in which different ones of said applications is responsible for updating different portions of common business objects corresponding to a particular common business object definition.

10. A computer architecture as recited in claim 8, wherein said system of record policies include a revolving policy in which different ones of said applications is responsible for updating common business objects corresponding to a particular common business object definition at different points of the life cycle of the common business object.

11. A computer architecture as recited in claim 8, wherein said system of record policies include a rules based policy in which common business objects corresponding to a particular common business object definition are updated in different manners based on external factors applied to predetermined rules.

12. A computer architecture as recited in claim 8, wherein said system of record policies include a rules based policy in which common business objects are updated based on external factors as applied to predetermined rules.

13. A computer architecture as recited in claim 1, wherein said integration platform comprises at least one connector having a transformation map, said transformation map comprising plural map modules applied in seriatim.

14. A computer architecture as recited in claim 13, wherein said plural map modules comprise a first map module having a data map for the canonical object, a second map module having a data map for a user extension and a third map module having a data map for an application extension.

15. A method of defining a common data object for sharing information between plural applications having disparate data structures, said method comprising:
identifying one or more primary applications each having a data structure;
determining common data elements between the data structures;
selecting elements of a canonical object that correspond to the common elements;
adjusting the canonical object based on a common object standard; and
adding at least one application specific or user specific extension to the data elements of the canonical object.

16. The method as recited in claim 15, wherein said adding step comprises adding data elements of a specified application to maintain functionality of the specified application in a system using the common object.

17. The method as recited in claim 15, wherein said adding step comprises adding data elements of one or more applications to maintain functionality desired by specified users in a system using the common object.

18. A common object definition for common objects used for sharing information between plural applications having disparate data structures, said definition comprising:
a canonical object defining elements of a standard object that are common between data structures of said plural applications; and
at least one extension defining application specific or user specific elements, said canonical object being exposed to all of the applications, said extension being exposed only to selected ones of the plural applications.

19. A definition as recited in claim 18, wherein said at least one extension comprises an application specific extension having data elements used only by a first of plural applications and a user specific extension having data elements not in said canonical object but desired by a specific user.

20. A definition as recited in claim 18, wherein said canonical object and said extension are defined by a tree like structure.

21. A computer architecture as recited in claim 20, wherein each of said canonical object and said extensions are represented by a separate node.

22. A computer architecture as recited in claim 20, wherein each of said canonical object and said extensions are represented by a distinct DTD.

23. A computer architecture as recited in claim 20, wherein said common object definition references another common object definition.
